(19) United States
(12) Patent Application Publication
(10) Pub. No.: US 2025/0286195 A1
(43) Pub. Date: Sep. 11, 2025

(54) BATTERY PACK

(71) Applicant: TOYOTA JIDOSHA KABUSHIKI KAISHA, Toyota-shi Aichi-ken (JP)

(72) Inventor: Nobuyasu NISHIKI, Toyokawa-shi Aichi-ken (JP)

(73) Assignee: TOYOTA JIDOSHA KABUSHIKI KAISHA, Toyota-shi Aichi-ken (JP)

(21) Appl. No.: 19/068,540

(22) Filed: Mar. 3, 2025

(30) Foreign Application Priority Data
Mar. 6, 2024 (JP) 2024-034212

(51) Int. Cl. H01M 50/242; B60K 1/04; B60L 50/64; H01M 50/204; H01M 50/249

(52) U.S. Cl. CPC H01M 50/242; H01M 50/204; H01M 50/249; B60K 1/04; B60L 50/64; H01M 2220/20

(57) ABSTRACT

A battery pack includes: a case including a lower case and an upper case that face each other in a first direction; a battery stack that is housed in the case and includes a plurality of battery cells; a junction box that is housed in the case and includes a relay; and a cross portion that is housed in the case, is disposed between the battery stack and the junction box in a second direction orthogonal to the first direction, and is fixed to the lower case. The junction box is attached to the cross portion, and the junction box includes a first portion disposed at a position overlapping the cross portion in the first direction, the first portion extending in the first direction and contacting the upper case.

The present application claims priority to and incorporates by reference the entire contents of Japanese Patent Application No. 2024-034212 filed in Japan on Mar. 6, 2024.

### BACKGROUND

The present disclosure relates to a battery pack.

JP 2020-095784 A discloses a power storage device in which a cross portion is disposed between a junction box, which is an electronic device, and a battery module in a housing case.

In the power storage device disclosed in JP 2020-095784 A, there is room for improvement in reducing noise generated when a relay provided in the junction box is operated.

Therefore, there is a need for a battery pack capable of reducing noise generated when a relay provided in a junction box is operated.

### SUMMARY

According to one aspect of the present disclosure, a battery pack includes: a case including a lower case and an upper case that face each other in a first direction; a battery stack that is housed in the case and includes a plurality of battery cells; a junction box that is housed in the case and includes a relay; and a cross portion that is housed in the case, is disposed between the battery stack and the junction box in a second direction orthogonal to the first direction, and is fixed to the lower case. The junction box is attached to the cross portion, and the junction box includes a first portion disposed at a position overlapping the cross portion in the first direction, the first portion extending in the first direction and contacting the upper case.

The above and other features, advantages and technical and industrial significance of this disclosure will be better understood by reading the following detailed description of the embodiments of the disclosure, when considered in connection with the accompanying drawings.

### BRIEF DESCRIPTION OF THE DRAWINGS

FIG. 1 is a diagram illustrating a schematic configuration of a main part of a battery pack according to an embodiment as viewed from a side of the vehicle.

FIG. 2 is an enlarged view of the junction box and its vicinity as viewed from the side of the vehicle; and

FIG. 3 is a diagram illustrating a schematic configuration of a main part of the battery pack according to the embodiment as viewed from the rear of the vehicle.

### DETAILED DESCRIPTION

Hereinafter, an embodiment of a battery pack according to the present disclosure will be described. Note that the present disclosure is not limited by the present embodiment.

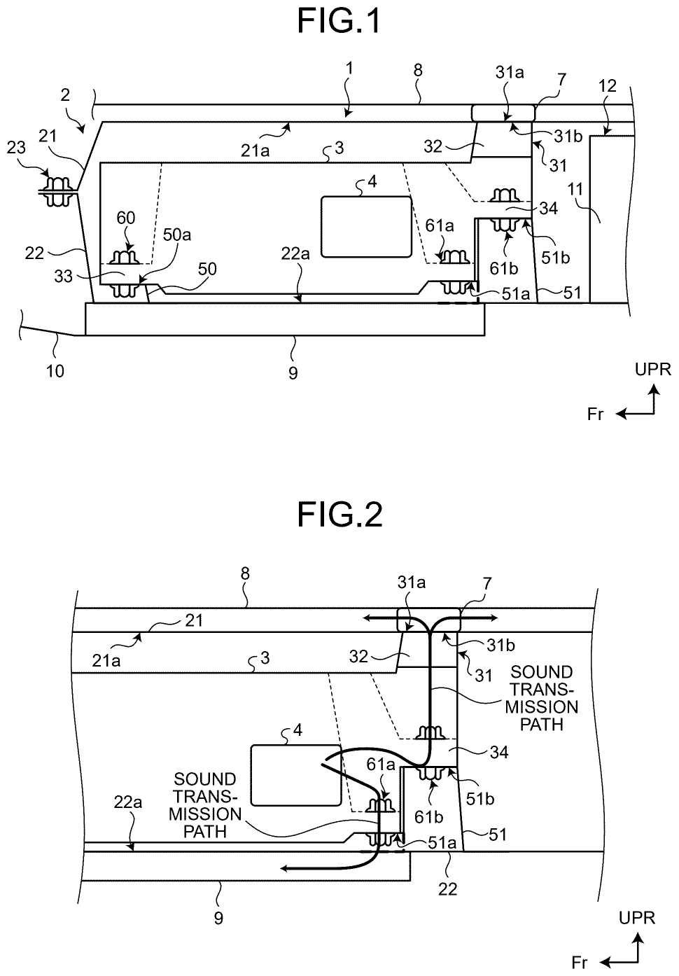

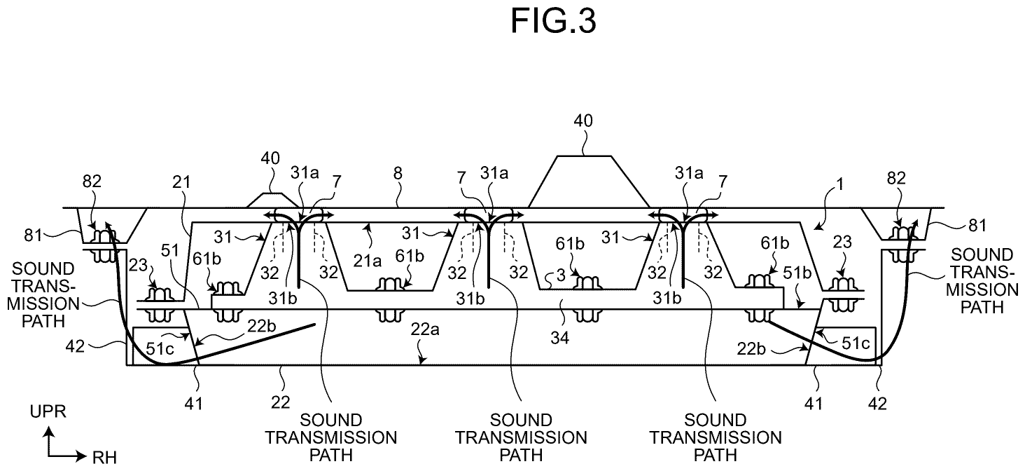

FIG. 1 is a diagram illustrating a schematic configuration of a main part of a battery pack 1 according to an embodiment as viewed from a side of a vehicle. FIG. 2 is an enlarged view of the junction box 3 and its vicinity as viewed from the side of the vehicle. FIG. 3 is a diagram illustrating a schematic configuration of a main part of the battery pack 1 according to the embodiment as viewed from the rear of the vehicle.

In FIGS. 1, 2, and 3, “UPR” indicates an upward direction in a vehicle height direction, which is a first direction. The first direction is not limited to the vehicle height direction, and includes a height direction of the battery pack 1, and is also the vehicle height direction in the present embodiment. In FIGS. 1 and 2, “Fr” indicates a frontward direction in a vehicle front-rear direction, which is a second direction perpendicular to the first direction. The second direction is not limited to the vehicle front-rear direction, and includes a front-rear direction of the battery pack 1, and is also a horizontal direction in the present embodiment. In FIG. 3, “RH” indicates a right direction in a vehicle width direction, which is a third direction perpendicular to both of the first direction and the second direction. The third direction is not limited to the vehicle width direction, and includes a width direction of the battery pack 1, and is also a horizontal direction in the present embodiment.

In addition, in FIGS. 2 and 3, a part of a transmission path through which a sound (vibration) generated when a relay 4 provided in the junction box 3 is operated is transmitted is indicated by an arrow.

As illustrated in FIG. 1, the battery pack 1 in the embodiment is mounted on an electric vehicle, and serves as a power supply source supplying electric power to a motor that is a drive source of the electric vehicle, for example. The battery pack 1 according to the embodiment includes a case 2 including an upper case 21 and a lower case 22 that face each other in the vehicle height direction. The upper case 21 and the lower case 22 include flanges fastened to each other by a fastening member 23 including bolts and nuts. A battery stack 12 including a plurality of battery cells 11 is accommodated in the case 2. Further, a first reinforcing portion 51, which is a cross portion disposed between the battery stack 12 and the junction box 3 and fixed to a bottom plate 22a of the lower case 22, is accommodated in the case 2.

A front-side attachment portion 33 for attachment to the attachment reinforcement 50 joined to the bottom plate 22a of the lower case 22 is provided on the front side of the junction box 3 in the front-rear direction of the vehicle. The front-side attachment portion 33 of the junction box 3 is fastened and attached to a flange 50a of the attachment reinforcement 50 by a fastening member 60 composed of bolts and nuts.

Further, a rear-side attachment portion 34 for attachment to the first reinforcing portion 51 joined to the bottom plate 22a of the lower case 22 is provided on the rear side of the junction box 3 in the front-rear direction of the vehicle. The rear-side attachment portion 34 of the junction box 3 is fastened to a front-side flange 51a and an upper surface portion 51b of the first reinforcing portion 51 by fastening members 61a and 61b including bolts and nuts, respectively.

The rear-side attachment portion 34 of the junction box 3 is provided with a support portion 31 that is a first portion in addition to a portion that is attached to the upper surface portion 51b of the first reinforcing portion 51 by the fastening member 61b.

The support portion 31 is disposed at a position overlapping with the first reinforcing portion 5 in the vehicle height direction and extends in the vehicle height direction, and has an upper surface 31a contacting a top plate 21a of the upper case 21. An inside of the support portion 31 is hollow, and a plurality of ribs 32 each having a surface along the vehicle front-rear direction and extending in the vehicle height direction are provided on a surface 31b of the support portion 31 opposite to the upper surface 31a. Accordingly, it is possible to suppress damage to the support portion 31 when an external load is applied to the upper side of the support portion 31 in the vehicle height direction. Further, by arranging the relay 4 on the front side of the support portion 31 in the junction box 3 when viewed from the rear in the vehicle front-rear direction, it is possible to utilize the support portion 31 as a shielding member that shields an impact in the vehicle front-rear direction.

On the top plate 21a of the upper case 21, a damper 7 is provided at a position that overlaps with the support portion 31 in the vehicle height direction on an outer side of the upper case 21 (battery pack 1). The damper 7 is sandwiched and compressed by the top plate 21a of the upper case 21 and a floor 8 provided above the upper case 21 (the battery pack 1). Thereby, the vibration transmitted from the battery pack 1 to the floor 8 side (body side) can be reduced by the damper 7.

Further, as shown in FIG. 3, a side bracket 41 to which the lower case 22 is attached and a side bracket 42 to which the side bracket 41 is attached are provided on an outside of the lower case 22 in the vehicle width direction. The side bracket 42 is fastened and attached to a mounting seat 81 provided on the floor 8 by a fastening member 82 including bolts and nuts. The battery pack 1 according to the embodiment has a structure in which both ends of the battery pack 1 in the vehicle width direction are supported by the side brackets 41 and the side brackets 42.

As shown in FIG. 1, a second reinforcing portion 9 is disposed on the front side in the vehicle front-rear direction and below the lower case 22. The second reinforcing portion 9 is attached to a front bracket 10 in front of the battery pack 1. The front bracket 10 is attached to a suspension member or the like provided on the front side of the vehicle. A mounting reinforcing portion 50 and the first reinforcing portion 51 are joined to the second reinforcing portion 9 via the lower case 22.

As shown in FIG. 3, the first reinforcing portion 51 is disposed so as to extend between both ends of the lower case 22 such that an outer surface 51c of the first reinforcing portion 51 and an inner surface 22b of the lower case 22 are contacted and connected in the vehicle width direction. Further, the rear-side attachment portion 34 of the junction box 3 also extends along the upper surface portion 51b of the first reinforcing portion 51 in the vehicle width direction, and a plurality of attachment portions by the fastening members 61b and the support portions 31 are alternately provided in the vehicle width direction.

As shown in FIG. 3, a plurality of skeleton members 40 are provided on the upper side of the floor 8. A lower portion of each of the skeleton members 40 is disposed on the floor 8 at a position that overlaps with the damper 7 in the vehicle height direction. Thus, in a state in which the damper 7 is sandwiched between the floor 8 and the upper case 21, the floor 8 is pressed downward by the skeleton member 40, thereby securing the rigidity of the floor 8 and securing the compression of the damper 7.

The relay 4 is a source of sound (vibration) in the junction box 3, and there are a large number of transmission members that transmit sound (vibration) rearward of the relay 4 are disposed in the junction box 3.

By attaching the rear-side attachment portion 34 of the junction box 3 to the first reinforcing portion 51, the first reinforcing portion 51 having high rigidity can be utilized in a wide range as a transmission member of sound (vibration) from the relay 4, and the transmission efficiency of sound (vibration) can be improved.

As shown in FIG. 2, a part of the sound (vibration) transmitted to the first reinforcing portion 51 is transmitted to the rear side of the second reinforcing portion 9 via the lower case 22. The sound (vibration) transmitted to the rear side of the second reinforcing portion 9 is transmitted to the front side of the second reinforcing portion 52 and is transmitted to the front bracket 10. The sound (vibration) transmitted to the front bracket 10 can be transmitted to the front side of the body via an attachment member such as a suspension member to which the front bracket 10 is attached.

Further, as shown in FIG. 3, a part of the sound (vibration) transmitted to the first reinforcing portion 51 is transmitted to the inner surface 22b of the lower case 22 from the outer surface 51c of the first reinforcing portion 51 in the vehicle-width direction. The sound (vibration) transmitted to the inner surface 22b of the lower case 22 can be transmitted to both sides of the floor 8 via the side bracket 41, the side bracket 42, and the mounting seat 81. Further, by using the first reinforcing portion 51 having high rigidity as a sound (vibration) transmitting member, the transmission efficiency of the sound (vibration) is improved, it is possible to efficiently transmit the sound (vibration) to the side brackets 41 and the side brackets 42 on both sides.

Further, the rear-side attachment portion 34 of the junction box 3 is not only attached to the first reinforcing portion 51, but also has a relationship of pressing the support portion 31 against the floor 8 via the upper case 21 and the damper 7. Therefore, the rigidity of the junction box 3 itself is improved, and in addition to the vibration resistance, the transmission efficiency of the sound (vibration) is also improved. Further, as shown in FIG. 2, by transmitting the sound (vibration) to the floor 8 by the support portion 31 of the junction box 3 through the upper case 21 and the damper 7, it is possible to obtain the damping effect due to the damper effect of the damper 7 and the reduction in the wide range of the floor 8.

As described above, in the battery pack 1 according to the embodiment, it is possible to provide a large number of transmission paths of the sound (vibration) generated when the relay 4 provided in the junction box 3 is operated, for the body including the floor 8, and it is possible to obtain a sound (vibration) damping effect over a wide range of the body.

In the battery pack according to the present disclosure, since the first portion of the junction box is in contact with the upper case, the vibration of the relay is transmitted to the upper case having a large mass, so that the sound generated when the relay provided in the junction box is operated can be reduced.

In the embodiment, the first portion may be fixed to the cross portion.

Thus, the vibration of the relay can be transmitted not only to the upper case but also to the lower case via the cross portion, and the noise generated when the relay is operated can be reduced.

In addition, the upper case may be provided with a damper at a position that overlaps the first portion in the first direction on the outside of the upper case.

This makes it possible to reduce vibration transmitted to the body side of the vehicle on which the battery pack is mounted.

Further, the inside of the first portion may be hollow, and a rib extending in the first direction may be provided inside the first portion.

Accordingly, it is possible to prevent the first portion from being damaged when the load is input from the outside to the first portion in the first direction.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general concept of the present disclosure as defined by the appended claims and their equivalents.

What is claimed is:

1. A battery pack comprising:
a case including a lower case and an upper case that face each other in a first direction;
a battery stack that is housed in the case and includes a plurality of battery cells;
a junction box that is housed in the case and includes a relay; and
a cross portion that is housed in the case, is disposed between the battery stack and the junction box in a second direction orthogonal to the first direction, and is fixed to the lower case, wherein
the junction box is attached to the cross portion, and
the junction box includes a first portion disposed at a position overlapping the cross portion in the first direction, the first portion extending in the first direction and contacting the upper case.

2. The battery pack according to claim 1, wherein the first portion is fixed to the cross portion.

3. The battery pack according to claim 2, wherein
the upper case is provided with a damper at a position that overlaps the first portion in the first direction on an outer side of the upper case.

4. The battery pack according to claim 3, wherein
the first portion has a hollow structure, and a rib extending in the first direction is provided inside the first portion.
